(19) United States
(12) Patent Application Publication
(10) Pub. No.: US 2020/0233684 A1
(43) Pub. Date: Jul. 23, 2020

(54) RUNNING APPLICATIONS ON A COMPUTING DEVICE

(71) Applicant: Appux Limited, Kidderminster (GB)

(72) Inventors: Stephen Horne, Kidderminster (GB); Peter Von Oven, Swindon (GB); Fabian Hemmer, Bochum (DE)

(21) Appl. No.: 15/758,752

(22) PCT Filed: Sep. 13, 2016
(86) PCT No.: PCT/GB2016/052823

§ 371 Date: Mar. 9, 2018

(30) Foreign Application Priority Data
Sep. 14, 2015 (GB) 1516227.4

(51) Int. Cl. G06F 9/455; G06F 8/61; G06F 21/53

(52) U.S. Cl. CPC G06F 9/4552; G06F 2221/033; G06F 21/53; G06F 8/61

(57) ABSTRACT

A method of running an application on a computing device, in which the computing device runs a first operating system (11; 31) (such as a thin web client operating system, such as Chrome OS) and the application runs on a second operating system (13; 33) (such as a fully-fledged operating system, such as Microsoft Windows®, Mac OS X®, Linux®), the computing device comprising storage (7) and a processor (2), the method comprising: loading an container package (12; 32) into the storage (7) and executing the container package (12; 32) on the processor (7), the container package (12; 32) acting as an emulator for the second operating system (13; 33); installing into the container package (12; 32) at least one application package (15; 35) each containing application code for the second operating system (13; 33); and running each application package (15; 35) on the processor (7), with the container package(12; 32) translating any requests that the application code makes to the second operating system (13;33) into corresponding requests of the first operating system (11; 31).

This invention relates to a method of running an application on a computing device and to an associated computer readable medium.

Driving down the cost of delivering information technology services to end users continues to be a one of the key deliverables when approaching new or transformational projects: how to deliver a better level of service at a reduced cost.

The current trend is for users to be more mobile, to use a device of their choice, and to deliver and consume applications from some form of online, cloud-based store where the applications are written for their specific device. This approach is perfect for the consumer market; however IT presents many challenges for commercial and enterprise based organisations.

First of all an enterprise organisation will have their own set of corporate applications, some of which are deemed to be legacy and not available as something they can consume from an online store, but which however are key to their business. The challenge is how to deliver these applications in the way that users want to consume them—on a device of their choice and whilst mobile.

The second challenge is around the need to be online and connected to the Internet. Most of the solutions available on the market today require the user to be always connected as the delivery of the application is being streamed in real time across the Internet to the device, or they are connecting remotely to an application that is running from within a datacentre. For locations without Internet access, or where the connection is severely restricted or not performant enough, this represents a problem.

In accordance with a first aspect of the invention, we provide a method of running an application on a computing device, in which the computing device runs a first operating system and the application runs on a second operating system, the computing device comprising storage and a processor, the method comprising:
loading an container package into the storage and executing the emulation package on the processor, the container package acting as an emulator for the second operating system;
installing into the container package at least one application package each containing application code for the second operating system; and
running each application package on the processor, with the container package translating any requests that the application code makes to the second operating system into corresponding requests of the first operating system.

Thus, by operating a two-stage packaging process, the running of applications destined for one operating system can be run on a different operating system, in a manner that is much easier for an end user to manage.

Typically, the first operating system is a thin web client operating system, such as Chrome OS®. The second operating system may be a fully-fledged operating system, such as Microsoft Windows®, Mac OS X®, Linux® or so on.

The method may comprise loading the container package into and/or executing the emulation package within a cache of a browser. Typically, the browser will have the Web Assembly (WASM) protocol enabled to ensure “just in time” (JIT) compilation and may also enable dynamic translation and platform independence.

This invention is particularly useful with thin web client operating systems, where the presumption when it is desired to run, say, Windows applications, is that they will be run on a remote server with a remote desktop connection (such as Virtual Network Computing (VNC) or Remote Desktop Protocol (RDP)) transmitting mouse and keyboard events to the remote server and the graphical output of the application back to the client. This removes the need to be permanently online.

In one embodiment, the container package may comprise a sandbox running an emulator, arranged to run each application package, and a local graphical terminal server. In this case, the method may further comprise running a front end program, which acts as a local graphical terminal client. Typically, the front end program may be an application native to the first operating system. As such, the method may comprise the container package generating graphical output and transmitting the graphical output through the local graphical terminal server to the local graphical terminal client, within the computing device. Likewise, the local graphical terminal client may transmit input events (such as keyboard and mouse events) from the front end program to the local graphical terminal server.

This is particularly useful where the sandbox runs a third operating system, which will typically be different to the first operating system. Such an arrangement allows for more flexibility than may otherwise be allowed with the first operating system; indeed, with the first operating system being Chrome OS it may be difficult to natively execute such an emulator. Typically, the third operating system may be a Linux® operating system. Where the second operating system is Microsoft Windows®, the emulator may be a compatibility layer, such as WINE® available from The Wine Project at http://www.winehq.org/.

Each application package may, as part of being run on the processor, generate at least one data file. The method may comprise storing each data file in a location selected from the group comprising at least one, or any combination of:
within the container package, optionally encrypted;
in the storage, outside of the container package; and
external to the computing device, typically in a remote location accessible through a network.

Where at least one data file is stored in the container package, at least one data file stored in the container package may be accessible to the first operating system; for example, it may be located on a shared folder within the container package. Alternatively, it may not be accessible outside of the container package except through each application package. Where at least one data file is stored external to the computing device, it may also be stored within a remotely-shared folder in the container package.

According to a second aspect of the invention, there is provided a computer-readable medium carrying program instructions, which when executed on a suitable processor, cause it to carry out the method of the first aspect of the invention.

There now follows, by way of example only, descriptions of embodiments of the invention, described with reference to the accompanying drawings, in which:

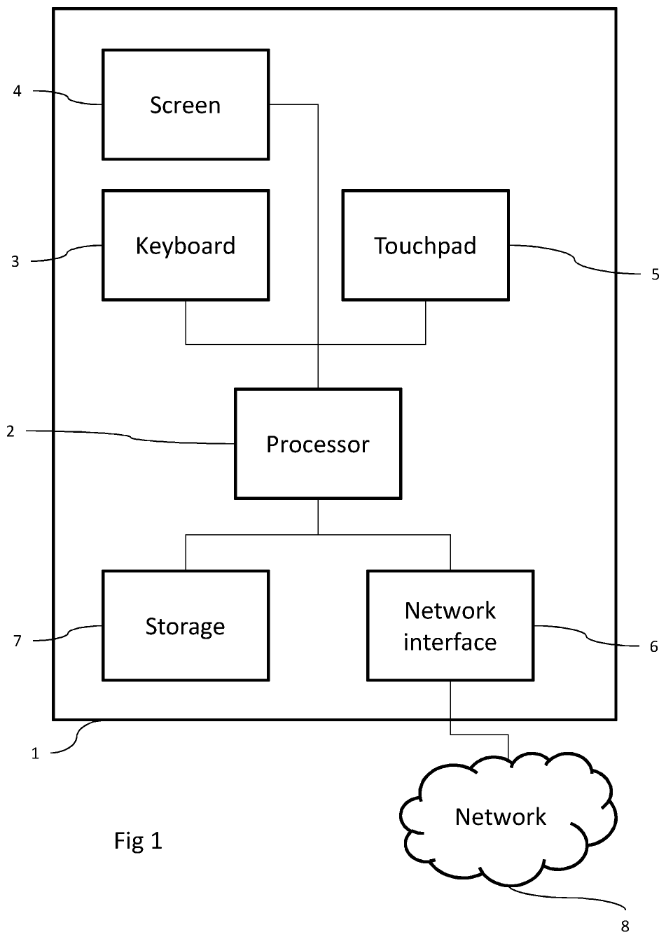

FIG. 1 shows a schematic representation of a computing device operated in accordance with a first embodiment of the invention; and

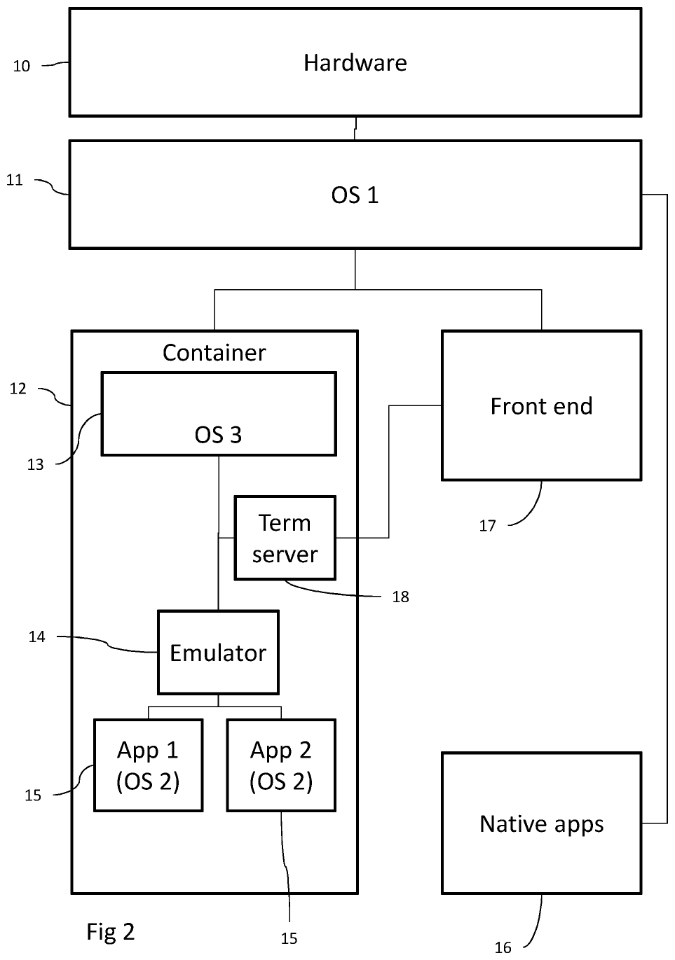

FIG. 2 shows the arrangement of functions within the computing device; and

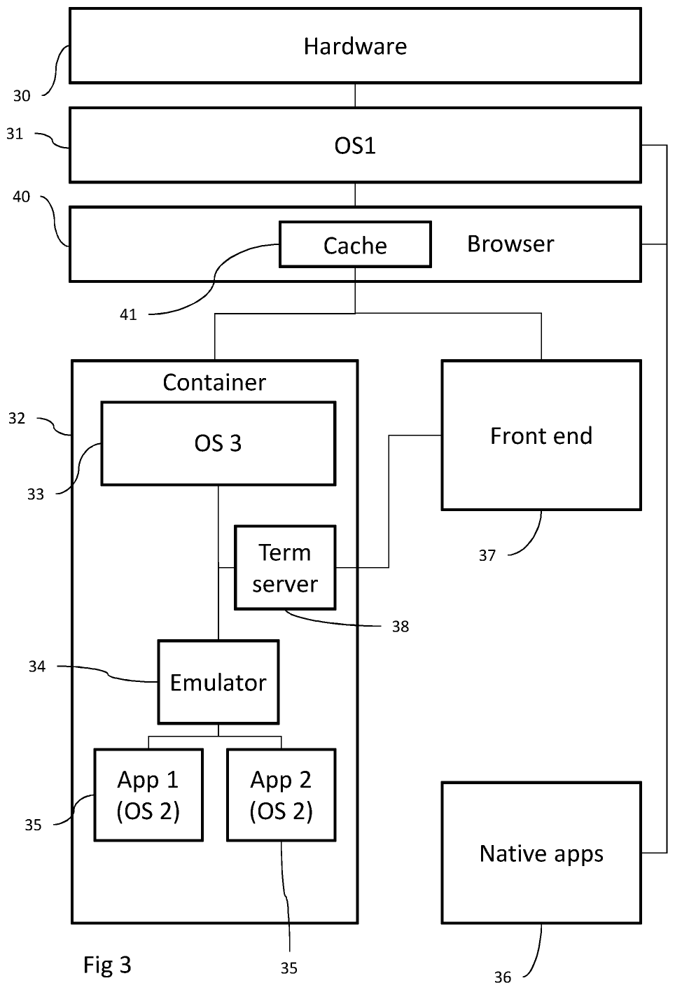

FIG. 3 shows an equivalent view to that of FIG. 2 of the functions of a computing device in accordance with a second embodiment of the invention.

A computing device operating in accordance with a first embodiment of the invention is shown in FIG. 1 of the accompanying drawings. The computing device 1 in this embodiment is a Chromebook®. It comprises a processor 2, with several input devices such as keyboard 3 and touchpad 5 (which generates mouse events), and an output such as screen 4. It also comprises storage 7 (including both random access memory RAM and flash mass storage) and a network interface 6 by means of which the computing device 1 can access a network 8 such as the Internet.

The operation of the device can be seen with respect to FIG. 2 of the accompanying drawings. The computing device natively runs a first operating system 11, in this case Chrome OS® which controls all access to the hardware 10 discussed above and has various native applications 16 (generally all stored in storage 7 and run on processor 2).

However, a user may wish to run applications 15 which run on a second operating system, such as Microsoft Windows®. As such, a container 12 of the form of a sandboxed virtual machine is installed on the computing device 1. The container 12 contains a third operating system 13, typically a lightweight Linux® installation. The container runs an emulator 14 and the other services that are required to execute each application 15. Once the container is established each application 15 is installed into it using the normal installation process for that application. The end result is a self-contained application container 12 comprising of all the components that are required to make sure each application 15 executes.

In order to create the container 12, a sandboxed Linux environment is created that is separated from the Chrome OS operating system 11 and runs in the background. Within this sandboxed Linux environment, there is installed a graphical terminal server 18 including a window manager which provides access to the graphical output of emulator 14 using a protocol such as Virtual Network Computing (VNC), Remote Desktop Protocol (RDP) or so on. The emulator 14 interprets calls made to the second operating system (that is, Windows), and redirects them to the appropriate calls to the third operating system 13.

Typically, the container will provide only a minimalistic cut down desktop environment for the applications to run on. This is only required to provide input to the application for keyboard and mouse functionality, font rendering, and finally the graphical terminal server 18 to provide a display interface to the end user.

The emulator 14 can be a compatibility layer such as WINE®. The implementation can vary by hardware and operating system type, but could be an emulator, a compatibility layer or a recompiler.

An additional component is a front end application 17, which runs on the first operation system 11. This communicates with the graphical terminal server 18 using the same protocol so that the graphical output from the emulator is shown on the screen 4 and to pass back keyboard and mouse events. This front end application 17 can be automatically installed and runs in background during the installation process. The front end application 17 can also provide an interface for installing and starting applications 15. It can also handle encrypting and decrypting the container 12 if desired.

The front end application 17 can display a user management interface that is used for managing applications 15 and can also manage the license keys for the installed applications 15. The front end allows the user, possibly based on their credentials and policy, to download applications and install them into the container 12. The front end also allows the end user to start and stop the container 12 as required. Finally the front end application 17 effects a graphical terminal client which allows the contents of the container 12, or the applications 15—the output of the graphical terminal server 18 to be displayed on display 4.

The container and the front end both need to be installed on the computing device 1 by the end user. Initially the container 12 starts as an empty container with no applications installed. The user then selects which applications 15 they want to install and once that application has been selected from the user interface it is downloaded and installed into the container. This installation process is handled by the front end application 17. When an application is launched by the user, the front end application 17 runs a application 15 specific command within the container 12 which in turn establishes a graphical terminal connection with that container 12. All other interactions with the container such as displaying the applications, mouse movement, and typing on the keyboard are all handled by that protocol

A typical installation script will have the following function:
1. Enable developer mode. This allows access to a Linux system (not necessary on certain systems such as Android, as this is already exposed). This is however a requirement for Chromebook devices.
2. Install a lightweight sandboxed Linux system—the container 12—so that the existing system is not affected and files can be encrypted.
3. Within the container 12: Install a graphical terminal server 17 for user interaction.
4. Install a compatibility layer or emulator 14 for Windows (or other OS) applications 15.
5. Install the front end application 17 under the native first OS 11.

Once the installation has been completed the user can now select an application 15 to run in the user interface by following the steps described below:
1. First run only: Download the application 15 and run its setup routine.
2. Start the application 15 and graphical terminal server 18 within the container 12.
3. Connect to the graphical terminal server 18 and show it in the frontend application 17.

When a user saves a file in one of the applications 15, they can be presented with several options:
1. If the file is within a special shared folder of the container 12, it can be seen in the file system of the first OS 11 (encrypted if desired).
2. If the file is within a special remote folder, it can be automatically shared with a remote file store (for example Google Docs) over network 8 (encrypted if desired)
3. Otherwise, it is only visible in the container, and may be encrypted.

As such, with Chrome OS as the first operating system and Windows as the second operating system, the container 12 can allow for a fully layered application container which includes an operating system kernel, an emulator, and then the ability to add and install a standard Microsoft Windows .exe or .msi based application. The process is designed to deliver a self-contained application in a single installer, thus simplifying the install process. Firstly a user would install the container 12 and then they would install the required applications into that container.

This embodiment allows the applications 15 to run on the device 1 in exactly the same way as a natively installed application would, and also allows the use of any local resources available on that device 1, such as a mouse pad or touch screen. It will also allow for the storing of user data files locally on the device 1, specified as a hidden file location or a standard drive or cloud hosted service. Files can be stored fully encrypted if the user chooses this option. The container will work with a standard application installer, thus enabling a user the ability to install legacy Windows applications without having to capture or repurpose the application required.

Each application 15 can be downloaded onto the device 1 and executed locally on the device 1 without the need to be connected to the network 8. It is only required to connect in order to perform the initial download of each application 15 package.

We have generated a working demonstration prototype of this product which allows an end user to run Microsoft Windows PowerPoint and Microsoft Windows Excel on a Chromebook device running Chrome OS. The applications 15 look, feel, and behave as if they were running on a standard Windows operating system.

A second embodiment of the invention is shown with respect to FIG. 3 of the accompanying drawings. Features in common with the previous embodiment are indicated with corresponding reference numerals, raised by 20.

In this embodiment, rather than running directly within the first OS 11, the container 32 runs within a browser 40 itself running on first OS 31. The container 32 is downloaded to, and run from, the cache 41 of the browser. Typically, this browser 40 will have the Web Assembly (WASM) protocol enabled to ensure “just in time” (JIT) compilation and also enable dynamic translation and platform independence.

1. A method of running an application on a computing device, in which the computing device runs a first operating system and the application runs on a second operating system, the computing device comprising storage and a processor, the method comprising:
loading a container package into the storage and executing the container package on the processor, the container package acting as an emulator for the second operating system;
installing into the container package at least one application package each containing application code for the second operating system; and
running each application package on the processor, with the container package translating any requests that the application code makes to the second operating system into corresponding requests of the first operating system.

2. The method of claim 1, in which the first operating system is a thin web client operating system, such as Chrome OS.

3. The method of claim 1, in which the second operating system is a fully-fledged operating system, such as Microsoft Windows®, Mac OS X®, Linux® or so on.

4. The method of claim 1, comprising loading the container package into and/or executing the emulation package within a cache of a browser.

5. The method of claim 1, in which the container package comprises a sandbox running an emulator, arranged to run each application package, and a local graphical terminal server.

6. The method of claim 5, comprising running a front end program, which acts as a local graphical terminal client.

7. The method of claim 6, comprising the container package generating graphical output and transmitting the graphical output through the local graphical terminal server to the local graphical terminal client, within the computing device.

8. The method of claim 6, in which the local graphical terminal client transmits input events, such as keyboard and mouse events, from the front end program to the local graphical terminal server.

9. The method of claim 5, in which the sandbox runs a third operating system, which will typically be different to the first operating system.

10. The method of claim 9 in which the third operating system is a Linux operating system.

11. The method of claim 5, in which the second operating system is Microsoft Windows®, and emulator is a compatibility layer, such as WINE.

12. The method of claim 1, in which each application package, as part of being run on the processor, generates at least one data file, the method comprising storing each data file in a location selected from the group comprising at least one, or any combination of:
within the container package, optionally encrypted;
in the storage, outside of the container package; and
external to the computing device, typically in a remote location accessible through a network.

13. The method of claim 12, in which at least one data file is stored in the container package, and at least one data file stored in the container package is accessible to the first operating system

14. The method of claim 12, in which at least one data file is stored in the container package, which is not accessible outside of the container package except through each application package.

15. The method of claim 12, in which at least one data file is stored external to the computing device, also being stored within a remotely-shared folder in the container package.

16. A computer-readable medium carrying program instructions, which when executed on a suitable processor, cause it to carry out the method of claim 1.
